(19) United States
(12) Patent Application Publication
(10) Pub. No.: US 2026/0308003 A1
(43) Pub. Date: Oct. 8, 2026

(54) DEVICE FOR PRODUCING LITHIUM CARBONATE CRYSTALS

(71) Applicant: K-UTEC AG SALT TECHNOLOGIES, Sondershausen (DE)

(72) Inventors: Bernd SCHULTHEIS, Kyffhäuserland (DE); Christoph NEY, Sondershausen (DE); Markus PFÄNDER, Erfurt (DE); Jenny HESS, Nordhausen (DE); Georg KATZMANN, Kyffhäuserland (DE); Jing WANG, Sondershausen (DE)

(21) Appl. No.: 19/490,261

(22) PCT Filed: Jun. 7, 2024
(86) PCT No.: PCT/EP2024/065811

§ 371 Date: Dec. 4, 2025

(30) Foreign Application Priority Data
Jun. 7, 2023 (DE) 10 2023 114 974.1

(51) Int. Cl. C01D 15/08; B01D 9/00

(52) U.S. Cl. CPC C01D 15/08; B01D 9/0018; B01D 2009/0086; C01P 2004/32; C01P 2004/51; C01P 2004/60

(57) ABSTRACT

The invention relates to a device and a method for the continuous, controlled crystallisation of metal salt crystals, in particular lithium carbonate crystals. These crystals can be produced with a high degree of homogeneity on a large scale.

The invention relates in particular to a device for the continuous and controlled crystallization of lithium carbonate, but can also be used for comparable, preferably inorganic crystals.

The device according to the invention is suitable for producing crystals with a defined grain size, particle distribution, and grain structure, especially lithium carbonate, but also other metal hydroxides, metal carbonates, metal sulfates, metal nitrates, amino acids, and carboxylic acids, as well as their salts, by precipitation from their aqueous solutions.

The basic principle of crystallization or precipitation of solids from an aqueous solution is to cause supersaturation of the dissolved solid in the aqueous solution in order to carry out the crystallization or precipitation process in a controlled manner by reducing the supersaturation. This can be done in various ways. One option is the precipitation reaction, in which the solution of a reactant is placed in a stirred vessel and a corresponding precipitating agent is added dropwise or otherwise dosed while stirring. Ideally, the precipitated particles should have a homogeneous particle size and uniform particle structure. Even in continuous processes, in which the reactant and precipitating agent are fed continuously, it is important to ensure homogeneous reaction conditions in the stirred vessel and to avoid uncontrolled crystal formation. In the case of lithium carbonate production, for example, lithium carbonate (Li₂CO₃) can be produced by adding alkali carbonates (precipitating agents) to a lithium salt solution (reactant). Similarly, lithium carbonate (Li₂CO₃) can be precipitated by adding lithium salts (precipitating agents) to pre-added alkali carbonates (reactant). In continuous processes, lithium salt solutions and alkali carbonate salt solutions can be continuously fed into a solution and/or suspension in the reaction vessel or reactor. The reaction can be controlled by increasing or decreasing the temperature and, optionally, by the dosage ratios.

In another precipitation reaction, lithium carbonate (Li₂CO₃) is produced by carbonating a lithium hydroxide (LiOH) solution, i.e., by introducing CO₂ (g) or CO₂ dissolved in water into a lithium hydroxide solution. In continuous processes, LiOH solution and CO₂ (g) or CO₂ dissolved in water can be continuously fed into a solution and/or suspension in the reaction vessel or reactor. The reaction can be controlled by increasing or decreasing the temperature and the dosing rate of the reactants.

Another precipitation process is based on the thermally induced decomposition of lithium hydrogen carbonate (Li₂CO₃) dissolved in water. Here, a purified lithium hydrogen carbonate solution is decomposed into CO₂ (gaseous) and lithium carbonate (Li₂CO₃) as a precipitation product by thermal exposure. A specific embodiment of this production of lithium carbonate is described, for example, in EP 2 536 663. In principle, this method of producing high-purity lithium carbonate can be based on a lithium carbonate solution (Li₂CO₃) (aq), which is converted into a lithium hydrogen carbonate solution by adding CO₂ (g) or CO₂ dissolved in water, which can be purified, for example, by ion exchange. The lithium hydrogen carbonate (aq) purified in this way can be used for the crystallization of high-purity lithium carbonate by thermal decomposition with CO₂ release.

The method of reaction crystallization of mineral salts on an industrial scale is described in DD 227615 and DD 26479. The reactor or crystallizer essentially consists of a cylindrical container, possibly with a flat, domed, or conical bottom, an axial stirrer with a guide tube, and a clarifying ring to separate a ring-shaped clarifying chamber from the rest of the suspension-filled crystallizer contents, as well as feed and discharge elements for the solid and liquid substances. The crystallizer from DD 227615 makes it possible to continuously mix the solid and liquid starting materials, ensure the reaction process, achieve a high crystal density in the reaction chamber and thus obtain a coarse crystallize, which can be withdrawn from the reactor in a thickened, highly concentrated form, while the liquid reaction phases leave the reactor in a clarified state via an overflow. The axial agitator mixes the contents through the suction effect of the agitator, which starts at the upper end of the guide tube and is generated by the suction-type inclined blades of the agitator. The agitator conveys the sucked-in suspension to the bottom of the container and sucks it back in again after it has risen up the cylindrical container walls at the upper end of the guide tube. To prevent any flow vortex from the mixed container from passing parallel into the ring-shaped clarification zone (“clarifying ring”), a specific flow deflection is provided by a ring-shaped installation in the form of a deflection ring with a roof-shaped cover and, if necessary, a transfer of solids separated in the clarification chamber to a central part of the reactor.

However, this apparatus has limited applicability for the crystallization of mineral salts, such as lithium carbonate, on an industrial scale. In particular, it is not suitable for homogeneous crystal formation in reactions in which crystallization is induced or supported by an increase in temperature.

The inventors of the present invention were thus faced with the problem that a local increase in temperature, e.g., with at least one additional pipe that introduces a reactant and/or precipitating agent at high temperatures (so-called “steam lance”), leads to uncontrolled crystal growth in the vicinity of and, in particular, on the surface of the steam lance. Heat input via the outer walls of the crystallizer or by pumping the reaction medium through an external heat exchanger leads to similar problems. This results in product losses because the resulting crystal particles are not sufficiently homogenized. Furthermore, problems arise with cleaning and with the limited execution time of a continuous process. Maintenance intervals become shorter, the reactor becomes dirty, and the crystallization process becomes inefficient.

The problem underlying the present invention is therefore to provide an improved process or apparatus for producing homogeneous metal salt crystals with a defined, as homogeneous as possible grain distribution and grain structure. In particular, it is important to avoid the problems identified by the inventors, which result from an inhomogeneous temperature distribution.

### SUMMARY OF THE INVENTION

According to the invention, the problem is solved by a reactor comprising at least one reactor element which enables the supply of liquid or gaseous starting substances (e.g. medium, reactant, and/or precipitating agent) into the reactor chamber at an elevated temperature without creating an inner surface in the reactor chamber at which a temperature gradient relative to the reactor solution or reactor suspension arises.

In one embodiment of the first aspect of the invention, a thermally insulated steam lance, which is a thermally insulated feed pipe, is introduced into the reactor of the present invention. The steam lance is suitable for introducing starting materials in the form of gases, such as water steam or gaseous CO₂, or from aqueous solutions at high temperature into the reactor so that thermally induced or promoted crystallization can be initiated there. The thermal insulation prevents unwanted fouling on the surface of the feed pipe in the case of process media containing dissolved salts or solids whose solubility increases significantly as the temperature decreases.

In a preferred embodiment, the steam lance comprises an insulation jacket that thermally insulates a substance-carrying inner pipe in the steam lance from the reaction chamber in the reactor. The insulation jacket can be insulated by air or a thermally inert liquid, e.g., by a circulating supply and discharge liquid.

In particularly preferred embodiments, the insulation jacket comprises at least one insulation layer with a cooling medium, a conventional insulation medium, or a vacuum layer. In one embodiment, the insulation layer of the insulation jacket has a thermal conductivity of 0.05 W/(mK), e.g., with a layer thickness of 2 cm or more.

“Thermally insulated” means that there is at most a small, limited heat flow from the interior of the reactor to the steam lance, or to the interior of the steam lance, or in the opposite direction. The insulation layer serves as a measure to limit this heat flow. In preferred embodiments, an inlet pipe or a steam lance is then referred to as “thermally insulated” if the quotient of the thermal conductivity of the reactor medium λ_{R} and the boundary layer thickness d_{R} at the surface of the insulation layer on the reactor side is at least a factor of x greater than the quotient of the thermal conductivity of the insulation layer λ_{I} and its layer thickness d_{I}.

$$( {λ}_{R} / {d}_{R} ) \underline{>} x \cdot ( {λ}_{I} / {d}_{I} ) , where x > 1.$$

The factor x is equal to the value of the temperature difference between the inside of the steam lance and the medium temperature in the reactor. In a preferred embodiment, x is at least 5, more preferably at least 10.

The boundary layer thickness d_{R} is a variable that depends on the geometry and conditions in the reactor and is determined by the quotient of the Nusselt number and the given length of the steam lance.

Ideally, the insulation layer of the insulation jacket will have a thermal conductivity of 0.05 W/(mK) or less, preferably 0.01 W/(mK) or less, more preferably 0.005 W/(mK) or less. The thickness of the insulation layer is 0.1 cm or more, 0.2 cm or more, 0.5 cm or more, 1.0 cm or more, 1.5 cm or more, 2.0 cm or more, or 3.0 cm or more. With a thermal conductivity of 0.05 W/(mK) or less, layer thicknesses of 1.0 cm or more are common, preferably 1.5 cm or more, more preferably 2.0 cm or more; or most preferably 3.0 cm or more. With a thermal conductivity of 0.01 W/(mK) or less, layer thicknesses of 0.2 cm or more, 0.5 cm or more, or 1.0 cm or more are preferred; however, the larger layer thicknesses mentioned above are possible. With a thermal conductivity of 0.005 W/(mK) or less, layer thicknesses of 0.1 cm or more, 0.2 cm or more, or 0.5 cm or more are preferred; however, greater layer thicknesses are possible.

In practice, thermal insulation is achieved by applying at least one insulating layer to the surface of the feed pipe, which contains a vacuum or a coolant.

It is particularly preferred that the insulation jacket consists of several layers. The outer layer serves to prevent heat loss to the cooling medium. An inner layer prevents the medium flowing through the steam lance from cooling down. In principle, this embodiment is also suitable for introducing cold process media into a hot environment within the reactor without a relevant temperature gradient occurring at the surface of the steam lance. In this case, unwanted fouling on the surface of the feed pipe can be avoided in the case of process media containing dissolved salts or solids whose solubility increases significantly with rising temperature.

The temperature gradient between the surface of the steam lance and the interior of the reactor should be less than 1 K, preferably less than 0.1 K, and ideally not measurable. In this way, temperature-induced coating formation of crystals, e.g., Li₂CO₃ crystals, on the surface of the steam lance can be reduced or, preferably, completely avoided. The heat loss is of secondary importance as long as no crystal formation is induced.

According to the invention, no crystal coating, e.g., of Li₂CO₃, occurs on the surface of the steam lance, i.e., the coating of crystals, e.g., of Li₂CO₃, on the surface of the steam lance is limited to a maximum coating rate of 1·10⁻⁵ m/h, preferably to a maximum of 1·10⁻⁶ m/h. At a temperature gradient between the surface of the steam lance and the interior of the reactor of less than 1 K, preferably less than 0.1 K, a maximum of 1·10⁻⁵ m/h, preferably a maximum of 1·10⁻⁶ m/h, is achieved. Without thermal insulation, a temperature gradient of 10 K or more was established in tests on Li₂CO₃ crystallization, and a coating formation rate of less than 1 mm/h or 1·10⁻³ m/h could not be achieved.

In a preferred embodiment, the reactor comprises one or more steam lances for the supply of liquid or dissolved starting substances (medium, reactant and/or precipitating agent) that are introduced at specific defined positions of the reaction vessel, particularly preferably within the guide tube, in the area between the guide tube and the clarifying ring at the level of the guide tube upper edge, or in the interior of the clarifying ring on or below the process medium surface. Solids are added to the latter area directly onto the process medium surface.

In a particularly preferred embodiment of the invention, the reactor comprises at least one external circulation line. The circulation line has an inlet at the upper end of the reactor and an outlet at the lower end of the reactor, whereby the inlet and outlet may optionally be provided with heatable and/or coolable sleeves. In a preferred embodiment, the circulation line comprises a heating element at the inlet, which heats the supplied starting substance (such as medium, reactant, precipitating agent) before it enters the reactor. The inlet in this aspect of the invention is a steam lance as described above. In a preferred embodiment, the heating element consists of a T-shaped pipe in which steam or another heating medium such as hot water is mixed with the circulation flow.

The present invention offers a number of advantages over conventional methods and devices. For example, the reactor according to the invention and the associated method according to the invention are low in incrustations, which means that less maintenance is required. The homogenization during the crystallization process caused by the reactor results in a regular and narrow grain size distribution and thus improved filterability and washability. The resulting crystalline product contains lower amounts of water-insoluble, non-washable impurities. Production output per piece of equipment is increased, reactor service life is increased, and maintenance intervals are longer. For example, lithium carbonate can be provided as a spherical crystalline product that is particularly easy to wash out and further process. Lithium carbonate as a spherical crystalline product preferably has a median diameter of 0.15 mm to 0.75 mm and a narrow particle size distribution of 0.09 to 0.65 mm as the lower limit and 0.20 mm to 0.80 mm as the upper 10mass percentile, and particularly preferably a particle diameter of 0.20 with an even narrower distribution of 0.169 mm as the lower limit and 0.255 mm as the upper 10 mass percentile.

### DETAILED DESCRIPTION OF THE INVENTION

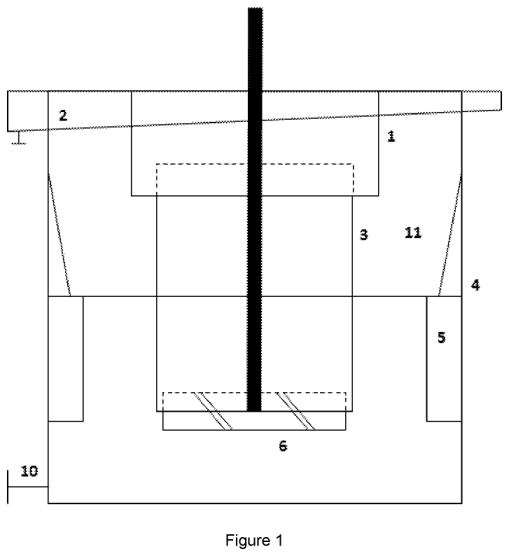

FIG. 1 describes a device (“reactor”) for crystallizing mineral salts, in particular lithium carbonate, comprising a cylindrical container, preferably with a straight, curved, or slightly conical bottom, with a centrally arranged axial stirrer (6) in a guide tube (3), which generates a flow directed towards the bottom of the container, as well as a clarifying ring (1) for clarifying the reactor overflow, an overflow channel (2) for collecting and discharging the reactor overflow, and an optional deflection ring (4) for supporting the clarification process. Optionally, the reactor comprises a wall flow breaker (5) for interrupting any tangential flow. A bottom outlet (10) is provided for removing the suspension. Such a reactor is known in the prior art.

In one embodiment, the device of the present invention is characterized by at least one thermally insulated feed pipe (7) (i.e., a thermally insulated steam lance (7)) for media, reactants, and/or precipitating agents, which protrudes into the interior of the reactor, preferably into the medium inside the reactor.

In preferred embodiments, the ratio of the height of the container to the container diameter is between 0.8 and 1.3, more preferably 0.9 to 1.2. The volume of the reactor is between 20 liters and 300 m³. For dimensioning, taking into account the specific properties of the solution under consideration, the necessary continuous tests are preferably carried out in volumes between 20 and 400 liters. A scale transfer is carried out on the basis of the factors specified for this reactor type, which are related to the reactor diameter, for the component dimensions. Li₂CO₃ is usually produced at a specific crystallization rate of 5-40 kg of product per 1 m³ of reactor volume per hour. Ideally, a low crystallization rate promotes better quality lithium carbonate. The reactor volume and thus the dimensions of all components are determined by the specific crystallization rate for a given production rate for Li₂ CO₃.

In principle, the reactor can be built with a volume greater than 300 m³ in accordance with the static conditions, but there is currently no practical operating experience available.

In regular embodiments, the bottom of the container is flat. In other preferred embodiments, the bottom of the container comprises a flat bottom inclined at an angle of up to 5° to the bottom outlet. In a further embodiment, the bottom is curved with a curvature that preferably extends to the wall flow breakers.

The clarifying ring (1) according to the reactor of the present invention, which serves to clarify the reactor overflow, preferably comprises a diameter of 50% of the tank diameter, with a preferred clarification height of 0.15 to 0.28 in relation to the tank height.

In a further preferred embodiment, the clarifying ring comprises a horizontal slit near the lower edge of the clarification.

The overflow channel (2) (here also referred to as “overflow”) of the reactor of the present invention serves to collect and drain the reactor overflow. It is preferably inclined at an angle of 1 to 5 degrees to the outlet. The width of the overflow channel depends on the overflow volume. It is preferably provided with maintenance hatches in the reactor cover so that any fine material that may have settled in the overflow channel can be flushed out.

The guide tube (3) of the reactor of the present invention serves to generate the desired flow conditions. The guide tube diameter is preferably 0.23 to 0.36 in relation to the container diameter. The guide tube length is preferably 0.49 to 0.82 in relation to the container height. The installation height of the guide tube preferably ends at a height of 0.092 to 0.42 in relation to the container height above the ground.

The deflection ring (4), which is optional in the reactor of the invention, serves to support the clarifying ring. The width of the deflection ring is preferably 0.07 to 0.10 in relation to the container diameter. The installation height extends to a maximum of 0.5 in relation to the container height (from the top to the center of the reactor). The inclination is preferably up to 30° to the vertical.

The wall flow breaker (5), optional in the reactor of the present invention, serves to prevent tangential flow. The width of the wall flow breaker is preferably up to 0.1 in relation to the container diameter. The installation height is preferably in the range between 0.046 and 0.128 in relation to the container height, in the lower half of the container. The agitator of the reactor of the present invention is preferably a 6-bladed agitator. The agitator diameter is preferably 0.21 to 0.33 in relation to the container diameter. The installation height of the agitator is preferably 0.08 to 0.020 in relation to the container height, with an agitator blade height of preferably between 0.042 and 0.066 in relation to the container diameter. The inclination of the agitator blades is preferably between 30° C. and 60° C.

The thermally insulated feed pipe (7) (i.e., the thermally insulated steam lance (7)) is suitable for introducing media, reactants, and/or precipitating agents with a temperature of 0° C. to the boiling temperature, ideally between 40° C. and 100° C., more preferably between 50° C. and 85° C. for precipitation processes and between 40° C. and 100° C., preferably between 80° C. and 100° C. for boiling solutions or for thermal decomposition or precipitation processes, for example the decomposition of dissolved lithium hydrogen carbonate by steam injection.

When dissolving lithium carbonate by reversing the crystallization processes, the feed pipe can be operated at 0° C. to 30° C., preferably at ambient temperature and ambient pressure.

During crystallization and/or dissolution, concentrations of lithium carbonate suspensions of 50 to 450 kg of solids per cubic meter at the reactor outlet are set by the withdrawal quantity at the reactor outlet. Preferably, the solids concentration at the reactor outlet is between 150 kg and 300 kg/m³. It is particularly preferable for this to be between 180 and 250 kg/m³ when lithium carbonate is produced from lithium chloride solutions. The mass flow of dissolved lithium salt required for precipitation is introduced through the feed pipe.

Economic aspects counteract the aspects of lithium carbonate quality, as the reactor volume and thus the investment costs increase as the specific crystallization or dissolution rate decreases. The preferred crystallization or dissolution rate is determined by product quality and economic aspects. Specific crystallization and dissolution rates between 5 and 25 kg/(m³h) are preferred for lithium carbonate. In the case of very high purity requirements or very narrow grain size distributions, a specific crystallization rate of less than 15 kg/(m³h) is particularly recommended for crystallization.

Precipitation processes according to the invention comprise the precipitation of lithium carbonate by adding lithium salt solution as a precipitating agent to an alkali carbonate solution (reactant). Similarly, an alkali carbonate solution can be added as a precipitating agent to a lithium salt solution (as reactant). Preferably, the alkali carbonate solution and lithium salt solution are introduced into the reactor through two different feed pipes.

In a further embodiment, solid lithium carbonate is precipitated from a lithium carbonate solution (reactant) by adding a lithium salt or a lithium salt solution (as a precipitating agent). Alternatively, the lithium salt or lithium salt solution can be added to the reactor so that solid lithium carbonate is precipitated by adding lithium carbonate solution as a precipitating agent. Preferably, the lithium salt solution and lithium carbonate solution are introduced into the reactor through two different feed pipes.

In a further embodiment, carbon dioxide (as a precipitating agent, gaseous or as an aqueous solution) is introduced into a lithium hydroxide solution. Similarly, a lithium hydroxide solution can be introduced into an aqueous carbon dioxide solution. Preferably, lithium hydroxide solution and carbon dioxide (gaseous or as an aqueous solution) are introduced into the reactor through two different feed pipes.

In a particularly preferred embodiment of the present invention, hot water or steam is introduced into a lithium hydrogen carbonate solution. The precipitating agent hot water or steam causes lithium carbonate to precipitate from the lithium hydrogen carbonate solution with the formation of carbon dioxide. This reaction can also be supported by pressurizing a lithium hydrogen carbonate solution located in the reactor. Similarly, a lithium hydrogen carbonate solution can be added to hot water in a reactor. Preferably, the lithium hydrogen carbonate solution and hot water or steam are introduced into the reactor through two different feed pipes.

In a further embodiment, in a reverse reaction to the preceding embodiment, carbon dioxide (gaseous) is introduced into a lithium carbonate suspension. Similarly, an aqueous solution mixed with carbon dioxide can be brought to form solid lithium carbonate by adding a lithium carbonate suspension. This produces a lithium hydrogen carbonate solution.

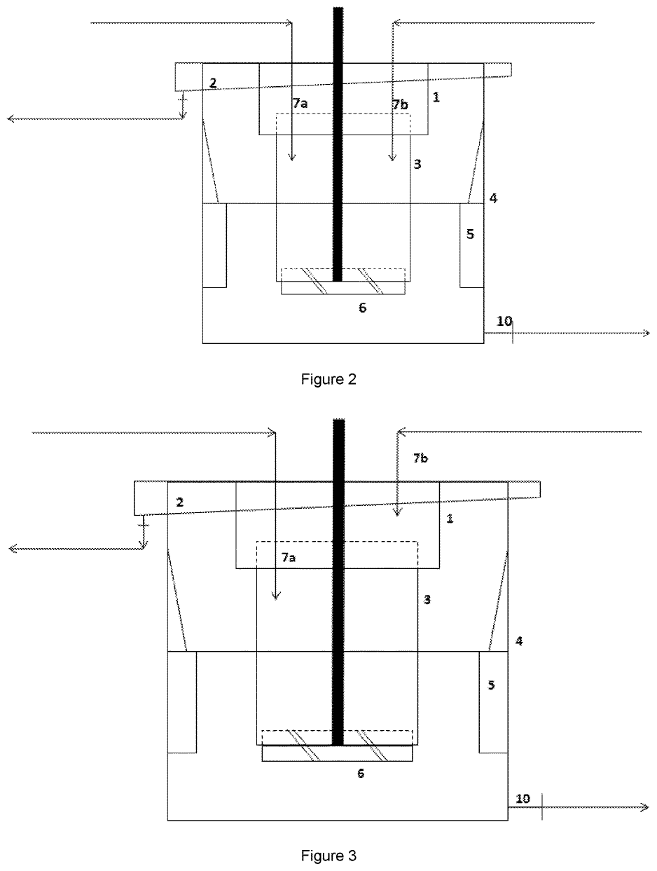

FIGS. 2 to 11 show preferred embodiments of the invention. Combinations of the various embodiments shown here are also possible.

FIG. 2 shows a reactor according to the invention with one, or optionally two, feed pipes (steam pipes) (7a), (7b). If there are two feed pipes, these can be inserted symmetrically to the axis of the stirrer in the guide tube (3), as shown here. The opening at the tip of the feed pipe protrudes into the interior of the guide tube.

According to FIG. 3, one asymmetrically mounted thermally insulated feed pipe (7a) (7b) are provided, whereby one thermally insulated feed pipe (7a) protrudes into the interior of the guide tube (3), while the other does not, i.e., the thermally insulated feed pipe (7b) with an opening at the tip of the feed pipe is inserted into another area of the reactor.

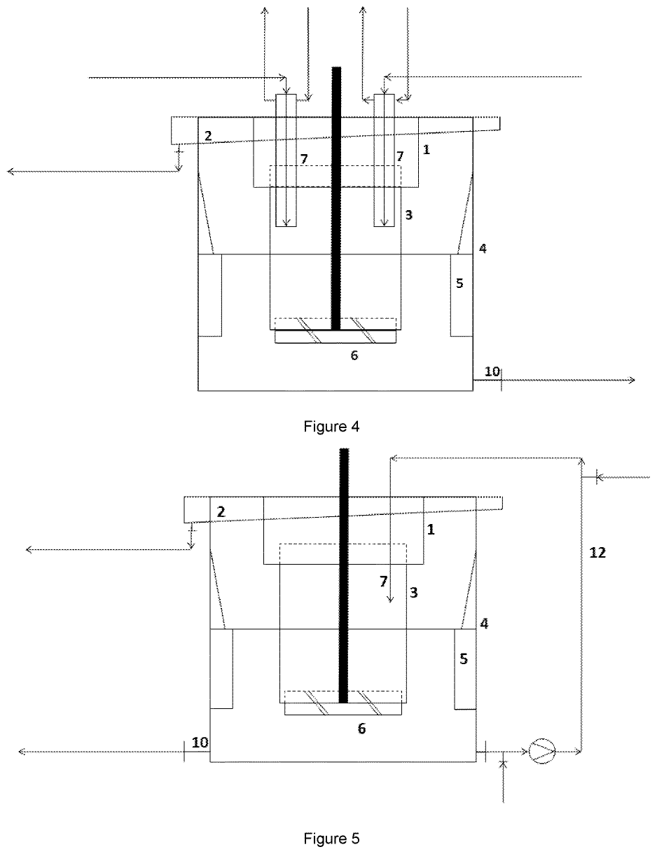

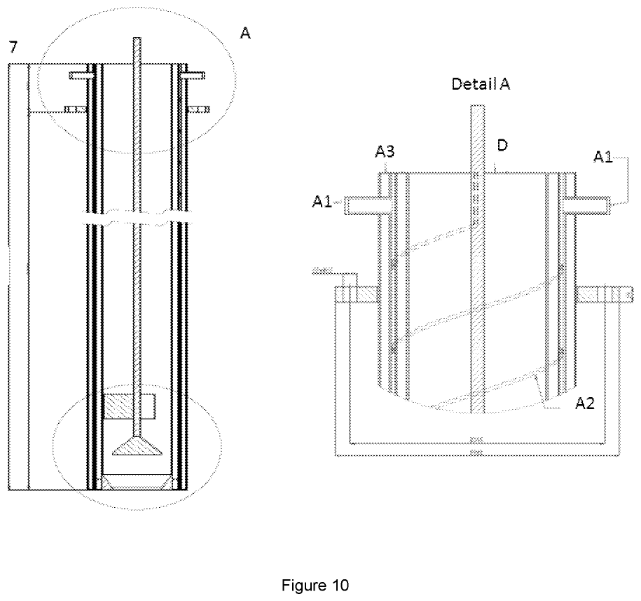

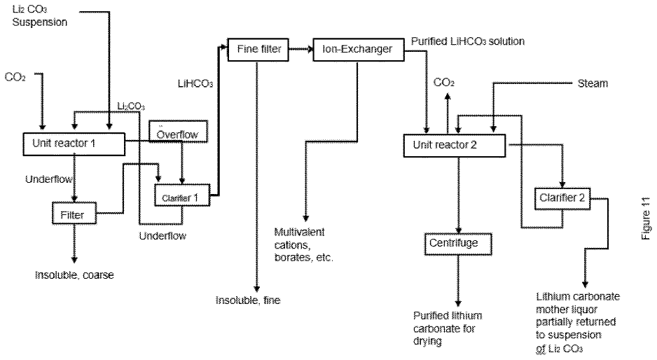

According to FIG. 4, the thermally insulated feed pipes (7) (i.e., the thermally insulated steam lances (7) or, in this case, also “thermally insulated injection pipes” (7)) can be heated or cooled by a cooling or heating circuit in the insulation jacket of the respective thermally insulated steam lance (7). The cooling or heating circuit may contain a cooling or heating fluid, a cooling or heating gas, or a vacuum. Preferably, the cooling or heating circuit is fed with an aqueous medium or with air. In a particularly preferred embodiment, the insulation jacket consists of three layers, which encases the thermally insulated inlet pipe (7) for CO₂ in a ring shape. The inner and outer layers of the insulation jacket each consist of a chamber filled with material that has a low thermal conductivity. This can be vacuum insulation panels, air, or other solid or gaseous insulation materials with a thermal conductivity of less than 0.05 W/(mK), preferably less than 0.01 W/(mK), and more preferably less than 0.005 W/(mK). The middle layer consists of a chamber arranged spirally around the longitudinal axis of the thermally insulated feed pipe (7), through which a cooling medium flows (see FIG. 10 below). The outer layer serves to minimize heat loss. This embodiment can also be used to cool the process medium in the crystallizer.

According to FIG. 5, the thermally insulated feed pipe is connected to an inflow pipe that leads out of the reactor, creating a circulation line (12). Optionally, the thermally insulated feed pipe (7) can also be fed by one or more additional supply pipes.

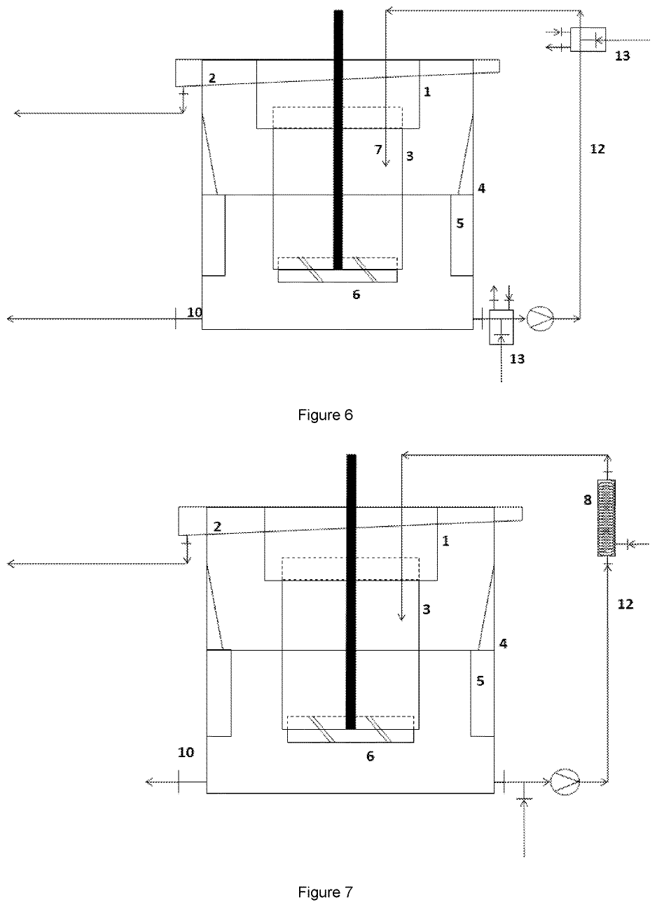

According to FIG. 6, which shows a preferred embodiment of FIG. 5, the circulation line is provided with cooling (or heating) collars (13), which are preferably attached directly to the entry points into the circulation line (12). In this particularly preferred embodiment, the T-shaped pipe used for mixing with the circulation flow can be cooled or heated on the side where the heating or cooling medium is introduced against the rest of the pipe in a similar manner as described for the steam lance.

According to FIG. 7, which shows a further preferred embodiment of the reactor according to FIG. 5, a static mixer (8) is integrated into the circulation line. The static mixer is a device for mixing liquids, or for mixing liquids with gases, whereby a homogeneous mixture of a mixture with a desired, adjustable mixing ratio is produced. Static mixers are known in the prior art in various embodiments. Preferably, the reaction temperature in the feed pipe is also set in the static mixer. The process parameters generated in the static mixer are as follows: A temperature in the range from 0° C. to boiling temperature is set, preferably between 40° C. and 85° C., for example between 80° C. and 100° C. For the dissolution of lithium carbonate, a temperature between 10° C. and 25° C. can be set. The flow velocity and thus the mixing speed can be set by the circulation volume flow for a given dimensioning of the static mixer.

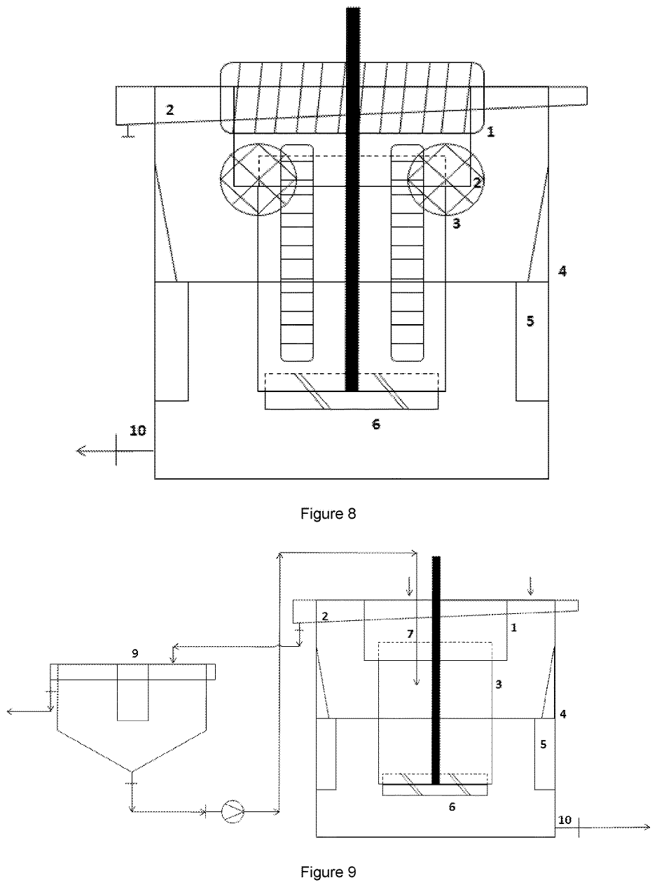

FIG. 8 shows preferred feed points, highlighted in hatched areas, at which the feed pipes (7) can introduce aqueous solutions and/or steam or CO₂ into the reactor vessel. In principle, it is possible to locate the openings at the respective tips of the feed pipes (here referred to as “feed points”) on the surface inside the clarifying ring (1), in the space between the clarifying ring (1) and the guide tube (3), or in the guide tube (3) itself. It is particularly preferred to introduce at least one feed point into the guide tube (3).

FIG. 9 shows an embodiment of the invention for the crystallization of lithium carbonate with external clarification. The reactor and a connected external clarification apparatus (9) are connected to each other via the overflow (2). The clarification overflow is collected in the external clarification apparatus (9) and from there, clarified crystals are returned from the underflow (i.e., bottom outlet) of the external clarification apparatus (9) to the reactor via the thermally insulated feed pipe (7). According to this embodiment, it is possible to collect lithium carbonate particles entrained with the reactor overflow in the clarification apparatus and return them to the reactor, which has a positive effect on grain growth. In addition, this embodiment allows the production of larger particles than would be possible with the reactor alone. Enlarging the diameter of the clarifying ring reduces the clarifying area in the reactor and thus increases the velocity of the solution flowing to the overflow. This also causes the average grain diameter of the Li₂CO₃ particles entrained with the overflowing solution to increase. Consequently, the average grain diameter of the particles retained in the reactor also increases. Since the overflowing solids are collected and returned in the clarifier, this material gradually grows to match the particle size distribution prevailing in the reactor, as the intensified classification effect means that the probability of retention in the reactor is only large enough to lead to a relevant population density if the particle diameter is sufficiently large. Due to the increased solids discharge, a larger volume flow is returned from the clarifier compared to a reactor without a downstream clarifier. This contributes to a further increase in the upward flow velocity in the clarifier area of the reactor and enhances the classification effect. The clarified solution can be separated in the external clarifier (9).

FIG. 10 shows an example of a thermally insulated feed pipe (7) (steam lance (7)) whose outer wall can be cooled with ambient air. The outer wall is thus insulated from the outside so that the outside temperature of the steam lance does not exceed and, preferably, does not fall below the reactor temperature in the reactor medium. This prevents incrustations on the outer wall of the steam lance. In other embodiments, the feed pipe or steam lance can be supplied with either a cooling or heating circuit. In the particularly preferred embodiment shown, the insulation jacket consists of three layers that encase the feed lance for CO₂ in a ring shape.

The inner and outer layers of the insulation jacket can each be filled with air (see A1, A3). The middle chamber, arranged spirally around the longitudinal axis of the steam lance, can be flowed through with cold ambient air (A2). This figure shows a comparatively inexpensive variant of the steam lance, for example for heating the lithium carbonate suspension when, for example, dissolved lithium hydrogen carbonate is to be decomposed and crystallized as lithium carbonate. Water steam (D) or an aqueous solution can be passed through the central pipe.

FIG. 11 shows a combination of two devices of the present invention, as can be used, for example, for purifying lithium carbonate. Contaminated lithium carbonate is dissolved in unit reactor 1. For this purpose, an aqueous suspension containing the contaminated lithium carbonate and CO₂ is continuously fed into the reactor to form lithium hydrogen carbonate. The reactor contains a sufficient amount of solid lithium carbonate, preferably with a concentration of 180-250 g/l. Coarse, insoluble impurities also remain in the reactor, whereby after a specified operating time, suspension is discharged from the bottom outlet (10) of the reactor and filtered to prevent excessive accumulation of impurities. The solid lithium carbonate discharged with the solution overflow (2) is collected in a downstream clarifier and returned to the unit reactor 1 with the clarifier underflow. The clarifier overflow is fed to a fine filter so that even the finest particles are removed from the lithium hydrogen carbonate solution stream. The design up to the fine filter ensures that, with temperature and pressure control, a lithium hydrogen carbonate solution with a constant lithium hydrogen carbonate concentration is produced. Since a sufficient amount of lithium carbonate solid is always available, the solution is always concentrated to near the solubility limit of lithium hydrogen carbonate. The dissolved amount of Li₂CO₃ is replenished by the Li₂CO₃ suspension so that the solid concentration in unit reactor 1 and thus also the conversion rate, preferably 15-25 (kg/m³h), remains constant. After the fine filter, the following ion exchangers serve to remove multivalent cations such as calcium, magnesium, or aluminum and/or borates, which are also dissolved by the CO₂, from the lithium hydrogen carbonate solution. Lithium carbonate is then recrystallized in unit reactor 2 using the invention's design with the addition of steam, drained at the bottom of unit reactor 2, and the solid lithium carbonate is separated using a centrifuge and transferred for drying. The solution overflowing from the clarifier is collected and, depending on the permissible concentration of other dissolved impurities such as sodium, potassium, chloride, or sulfate, is used in whole or in part to suspend contaminated lithium carbonate.

### Embodiments of the Invention

The present invention provides a device and a crystallization process.

According to a first embodiment, a device for thermally controlled precipitation crystallization is provided in the form of a reactor comprising a cylindrical container with a preferably flat, domed, or slightly conical bottom, with a centrally arranged axial stirrer (6) with a guide tube (3), which preferably generates a flow directed toward the container bottom, as well as an annular separating plate (1) (so-called “clarifying ring” (1)) concentrically surrounding the axial stirrer (6) for separating a clarifying ring space from the stirred container contents, and an overflow channel (2), characterized in that the reactor comprises a thermally insulated feed pipe (7) for introducing an aqueous phase or a gas phase, without having a surface inside the reactor which has a temperature gradient relative to the temperature of the reactor medium.

In a preferred embodiment, the thermally insulated feed pipe (7) comprises an opening, preferably at the tip of the feed pipe, which protrudes into the interior of the reactor vessel, wherein the thermally insulated feed pipe (7) is thermally insulated, preferably by a jacket which is fed with a cooling and/or heating medium. In a further embodiment, the jacket comprises a vacuum. Another embodiment contains air as an insulation layer. Yet another embodiment contains vacuum insulation or plastic foam. In a particularly preferred embodiment, the feed pipe is coated with three layers, wherein the inner and outer layers are thermally insulating as described and the middle layer regulates the temperature by supplying a heating or cooling medium in such a way that there is no longer a measurable temperature gradient between the surface of the feed pipe and the medium into which it is immersed.

In another embodiment of the present invention, the feed pipe is part of a circulation line (12) that is thermally controllable and can preferably adjust the reaction temperature in gradual steps.

In preferred embodiments, the above-mentioned embodiments comprise a reaction vessel which further has flow deflection means (4) (e.g., a deflection ring (4)) and a bottom outlet (10) suitable for product removal at the bottom of the vessel.

In other embodiments, the reactor of the present invention comprises an integrated clarification zone (11). Preferably, the reactor of the invention comprises an additional external clarifier (9) (or “clarifying apparatus” (9)) located outside the reactor, into which the reactor overflow from the overflow (2) is introduced. In the external clarifier (9), separated solid particles can be collected and returned to the reactor, thereby promoting crystal growth.

In a preferred embodiment, the external clarifier (9) is a clarifier cone without a rake, a round thickener with a rake, a lamella clarifier, a centrifuge, or a decanter.

In another preferred embodiment, the reactor of the invention comprises two or more thermally insulated feed pipes (7). Preferably, the thermally insulated feed pipes (7a, 7b) are arranged axially symmetrical to the axial stirrer (6).

In another embodiment, two thermally insulated feed pipes (7) are arranged asymmetrically (7a), (7b) with respect to the axial stirrer (6).

In a further embodiment, at least one thermally insulated feed pipe (7) is mounted in the guide tube of the reactor (3), i.e., the feed pipe opening at the tip of the thermally insulated feed pipe (7) preferably protrudes into the guide tube.

In a further embodiment, the reactor of the present invention comprises a deflection ring (4).

In a further embodiment, the reactor of the present invention comprises a wall flow breaker (5).

In a further embodiment, the reactor of the present invention comprises a bottom outlet (10).

In a further preferred embodiment, the reactor of the present invention comprises a six-bladed agitator (6a). The use of four-bladed or propeller agitators is also possible.

In a further embodiment, the reactor of the present invention comprises a static mixer (8).

In a further embodiment, the reactor of the present invention comprises a circulation line (12), preferably a heatable and/or coolable circulation line (12).

In a further preferred embodiment, the thermally insulated feed pipe (7) is a thermally insulated steam lance (7) whose outer wall can be cooled with ambient air or whose outer wall can be cooled or heated with a liquid medium. Preferably, the thermally insulated feed pipe (7) is surrounded by a triple insulation layer.

A crystallization process in a cylindrical reactor vessel equipped with an agitator is also provided, wherein the crystallization process comprises the following step:
a) initiating a precipitation reaction by supplying at least one liquid or gaseous medium into a medium inside the reactor, wherein the supplied medium has a different temperature, preferably a higher temperature than the reactor medium, whereby a temperature change occurs in the reaction medium inside the reactor, which induces or promotes the precipitation reaction, without introducing a surface into the reactor that creates a temperature gradient with respect to the reactor medium.

Preferably, according to the method of the present invention, a thermally insulated steam lance (7) is introduced into the reactor vessel.

More preferably, the supplied medium is supplied by means of a circulation line (12).

In a further embodiment of the present invention, a battery of two or more devices of the present invention is provided.

In a preferred embodiment, a battery of two devices (i.e., reactors) of the present invention is provided. Preferably, a reaction and a reverse reaction take place in these two devices. In this way, for example, a contaminated starting material can be purified. In a particularly preferred embodiment, contaminated lithium carbonate is converted into lithium hydrogen carbonate in a first apparatus of the battery with the addition of CO₂, which is converted back into pure lithium carbonate in a second apparatus of the battery with the addition of steam. In these embodiments, purification elements can be introduced between the two apparatuses, e.g., one or more ion exchangers and/or one or more filters. These embodiments are particularly advantageous in that they can be carried out in continuous operation.

In another preferred embodiment, a battery of three devices (hereinafter referred to as “apparatuses”) of the present invention is provided. This is used, for example, to convert solid Li₂CO₃ with a slightly excess stoichiometric amount of solid Ca(OH)₂ into dissolved LiOH and solid CaCO₃. The chosen embodiment favors the formation of a high concentration of dissolved LiOH with minimized lithium losses caused by undissolved or recrystallized Li₂CO₃ in the solid product CaCO₃. In these three battery devices, it is preferred that the conversion reaction takes place predominantly in the first apparatus and that the conversion reactions are quantitatively completed in the other two apparatuses. The reaction of Li₂ CO₃ with Ca(OH)₂ initially forms CaCO₃, which is significantly less soluble than the two reactants, with lithium dissolving as hydroxide. As the reaction progresses, the concentration of LiOH in the solution increases. This reduces the solubility of both Li₂CO₃ and Ca(OH)₂, which is why, when a LiOH concentration of more than 2.5 parts by mass in 100 parts by mass of solution is reached, the occurrence of solid Li₂CO₃ must be expected, which is lost from the process without further treatment with CaCO₃. For this reason, the water required for the process is added to the third apparatus, so that a CaCO₃ suspension with a solution containing only a low concentration of LiOH is produced there, which is dewatered after being removed from the apparatus in accordance with the invention. Due to the low lithium hydroxide concentration, only minor lithium losses occur, which can be further reduced by washing the filter cake. The filtrate, the wash filtrate, and the overflow from the third apparatus enter the second apparatus, which is additionally fed with the underflow from the first apparatus and the underflow from a clarification apparatus downstream of the first apparatus. The dilution effect thus achieved dissolves solid Li₂ CO₃ from the first apparatus is dissolved, which reacts with the Ca(OH)₂ that has not yet reacted to form LiOH and CaCO₃ and completes the reaction. The overflow from the first apparatus is fed into a clarification apparatus and clarified so that the clear solution flowing out of it can be further processed into lithium hydroxide monohydrate or other products using known methods.

In another embodiment of the invention, contaminated lithium carbonate is continuously dissolved in a unit reactor for the purification of lithium carbonate. In accordance with the dissolution rate of lithium carbonate, which is preferably between 10 kg/m³ h and 25 kg/m³h, fresh suspension with contaminated lithium carbonate is fed in so that a preferred solids concentration between 180 kg/m³ and 250 kg/m³³ in the lower region of the reactor. In order to avoid excessive accumulation of insoluble impurities, suspension is continuously or periodically withdrawn from the lower part of the reactor so that preferably at least 95 out of 100 mass parts of lithium carbonate in the contaminated feed material are dissolved. The criterion for the volume flow of the suspension withdrawal at the reactor outlet is to ensure the specific dissolution rate, which can be monitored by measuring the density, refractive index, or other characteristic parameters of the solution in the lithium hydrogen carbonate solution. The lithium carbonate withdrawn from the reactor outlet is used elsewhere. The solid lithium carbonate discharged with the solution overflow is collected in a downstream clarifier and returned to unit reactor 1 with the clarifier underflow. The clarifier overflow goes to a fine filter so that even the finest particles are removed from the lithium hydrogen carbonate solution stream. These fine particles are usually impurities and are also removed from the process. The fine filter is followed by ion exchangers, which serve to remove dissolved multivalent cations such as calcium, magnesium, or aluminum and/or borates from the lithium hydrogen carbonate solution. They are preferably regenerated with diluted hydrochloric or nitric acid. They are preferably conditioned with diluted lithium hydroxide solution. This prevents the accumulation of other alkali metals, which would be the case if potassium hydroxide or sodium hydroxide were used instead of lithium hydroxide. The lithium hydrogen carbonate solution purified in this way is then used to produce lithium carbonate again. For this purpose, it is crystallized with a specific crystallization rate of 10-25 kg/hm³ using steam with the structure according to the invention, separated with a centrifuge, washed if necessary, and transferred for drying. The solution overflowing from the clarifier is collected and, depending on the permissible concentration of other dissolved impurities such as sodium, potassium, chloride, or sulfate, is used in whole or in part to suspend contaminated lithium carbonate. In a particularly preferred variant of this embodiment, the solution used to suspend the contaminated lithium carbonate is cooled by means of water evaporation and the evaporated water is compressed so that it is returned to the invention-compliant structure as heating steam, thereby reducing thermal energy consumption.

In a further embodiment, lithium carbonate is crystallized in a reactor according to one of the embodiments described and either separated from the mother liquor or enriched in it. The lithium carbonate then enters a second reactor corresponding to the embodiments described, which is equipped with at least two, preferably three, steam columns corresponding to one of the embodiments of the invention. The previously produced lithium carbonate is preferably introduced in suspended form through a steam column. A solution containing a further metal salt is introduced through another steam lance. At least one further steam lance introduces a medium which either leads to supersaturation of the further cation introduced into the reactor or, in a preferred variant, provides a further anion which forms a precipitate with the further cation, the precipitation of the product being driven by the lithium carbonate present. Due to the structure according to the invention, the lithium carbonate particles provide a large amount of growth surface, so that the Li₂CO₃ particles are evenly coated with a layer containing the precipitate of the metal salt. The order of precipitation can be reversed if necessary, so that lithium carbonate coats particles consisting of another cation or anion.

In a further embodiment of the present invention, lithium salt solutions are processed in a series of successive crystallization steps, which, in addition to lithium as a cation, may also contain other cations and anions that hinder the crystallization of a battery-grade lithium carbonate. The embodiments and operating principles described in the invention are used to first crystallize one or more cations and/or anions in at least two successive crystallization or precipitation steps without lithium being precipitated in relevant quantities. In the last crystallization unit according to the invention, lithium carbonate is crystallized using one of the embodiments described. Depending on the application, the crystallization or precipitation of the interfering ions can take place in one crystallization unit according to the invention per cation or anion or synchronously with the precipitation of several cations and/or anions in one crystallization unit according to the invention (=device of the invention). Common cations that must be almost completely removed from the solution are calcium or magnesium. Common anions that have an influence on the crystallization and purity of lithium carbonate are sulfate and borates.

### EXAMPLES

### Example 1: Precipitation of Lithium Carbonate by Decarbonization of a Lithium Hydrogen Carbonate Solution

a) A lithium hydrogen carbonate solution with 75 g/l LiHCO₃ stored at ambient temperature is pumped at a rate of 10 liters/h through a steam-heated plate heat exchanger, heated to 95° C., and then fed into a crystallization reactor according to the invention. After 25 minutes, the experiment was interrupted because only 75° C. had been reached and the flow rate had decreased to below 7 l/h. After flushing the plate heat exchanger with hydrochloric acid, the original solution flow rate and the target temperature of 95° C. were briefly achieved again. As there was another massive drop in both process parameters, the experiment was terminated.
b) In a second test run, the same solution was fed at a rate of 10 liters/h directly via a steam lance consisting of a simple pipe into the mixing zone within the clarifying ring of the reactor according to the invention, which has a volume of 400 liters, and the system was heated with steam flowing through a steam lance consisting of a simple injection pipe protruding into the guide tube of the reactor according to the invention. The process was operated for a period of 8 hours before it was terminated as planned. Within this time, the solid concentration increased to 3 g/l. Approximately 600 g of Li₂CO₃ coated the steam injection pipe.
c) By using a thermally insulated steam lance in the experimental setup and procedure of b), no solid Li₂CO₃ was deposited on the steam lance surface under the same experimental conditions as in b).

### Example 2

For the Li₂ CO₃ precipitation, a total of four experiments were carried out on a small pilot scale (20 liter reactor volume) in two different scenarios, each with a conventional setup with three overflow-operated stirring vessels with a guide tube and a loop reactor setup. The experimental work is summarized in the table below. All experiments were carried out at approximately 70° C.

TABLE
Simplified overview of the test work carried out on Li₂CO₃precipitation

| | | | Solid | Average solids | |
|---|---|---|---|---|---|
| | | | concentration | retention time | Duration of |
| Experiment | Setup | Scenario | [g/l] | [h] | test [h] |
| 01 | Conventional | Low-sulfate | 23 | 1.8 | 8 |
| 02 | Grinding | solution | 230 | 10 | 32 |
| | reactor | | | | |
| 03 | Conventional | high K | 23 | 1.8 | 8 |
| 04 | Loop reactor | concentration | 230 | 10 | 32 |

### Scenario:

Low sulfate solution: The brine contains 0.9% lithium, 6.2% sodium, 13% chloride, and 0.02% sulfate.

High potassium content: The brine contains 0.9% lithium, 4.2% sodium, 3.0% potassium, 12.7% chloride, and 0.12% sulfate.

In scenarios 1 and 3, the lithium solutions are divided. For the first of the stirred tank cascade, the lithium solution is fed in at a rate of 19 liters per hour via an injection pipe. In the same way, 8 liters per hour of lithium solution are fed into the second tank of the cascade. A solution containing 30% sodium carbonate is used to precipitate lithium carbonate, which is fed into the first stirred tank in the cascade via an injection pipe. The third stirred tank in the cascade serves to extend the residence time. The suspension leaving the stirred tank cascade is collected in a clarifier and the solids are thickened, filtered, washed to remove adhesive lye, and analyzed.

Scenarios 2 and 4 are carried out in a setup corresponding to FIG. 9. Heating and temperature control are carried out using a steam lance as shown in FIG. 4, by feeding in approximately 1 liter per hour of a steam-water mixture. In the crystallization reactor according to the invention, 8.7 liters per hour of lithium solution and 2.1 liters per hour of soda solution are fed simultaneously via a setup corresponding to FIG. 2. From the tenth hour onwards, 2 liters per hour of product suspension are withdrawn from the reactor underflow and this is continued until the 32nd hour of the experiment. The overflow from the reactor enters a clarifier in which the entrained solid particles are collected and returned to the reactor via the underflow of the clarifier. This recirculation begins with the first hour of the experiment. The extracted suspension is filtered, washed to remove adhesive lye, and the product is analyzed. The following impurities are found in the product

| | Scenario | | | |
|---|---|---|---|---|
| | 1 | 2 | 3 | 4 |
| | Conventional | Loop | Conventional | Loop |
| Li | 18.776% | 18.781% | 18.771% | 18.774% |
| Na | 0.038% | 0.018% | 0.024% | 0.016 |
| K | 0.000 | 0.000 | 0.011 | 0.000% |
| SO4 | 0.007% | 0.005% | 0.034% | 0.037% |
| CO3 | 81.167% | 81.185% | 81.145% | 81.155% |
| Purity | 99.943% | 99.965% | 99.916% | 99.928% |

When using the setup according to the invention, higher purities are achieved, particularly for the elements sodium and potassium. In addition, lower residual moisture levels can be achieved during dewatering, which, according to the structure according to the invention, are between 6% and 8% after centrifugation, whereas with conventional structures, residual moisture levels between 9% and 12% are achieved. Differences also occur in the particle size distribution, with a considerably larger range for the 10% percentile and multimodal distribution and considerably lower modal values of the main distribution in the conventional structure. These are summarized in the following table:

| | | Scenario | | | |
|---|---|---|---|---|---|
| | | 1 | 2 | 3 | 4 |
| | | Conventional | Loop | Conventional | Loop |
| Wingspan | mm | 0.001- | 0.010- | 0.001- | 0.010- |
| | | 3.000 | 0.600 | 3.000 | 0.600 |
| Type | | bimodal | unimodal | bimodal | unimodal |
| Modal value | mm | 0.15 | 0.20 | 0.16 | 0.22 |

### Example 3: Production of Spherical Lithium Carbonate by Precipitation from a Lithium Sulfate Solution

A mass flow of 10.5 kg per hour of a solution containing 7.3% Li₂SO₄, 13.4% Na₂SO₄, 6.3% K₂ SO₄ and traces of calcium, magnesium, rubidium, and cesium is introduced at a temperature of 22° C. into the interior of the reactor's guide tube via a steam lance according to the invention, as shown in FIG. 5. At the same time, 2 kg per hour of a 33% sodium carbonate solution is introduced into the interior of the guide tube via a steam lance according to the invention, as shown in FIG. 4, in such a way that the amount of lithium ions introduced to the amount of carbonate ions introduced has a molar ratio of 2.21:1. In this way, 477 g of lithium carbonate are crystallized per hour. By using a reactor according to the invention with a volume of 20 liters, the above conditions correspond to a specific production rate of 23.9 kg/(m³h). After solid-liquid separation and washing, a product with a purity of 99% is obtained with sodium sulfate, potassium sulfate, and lithium sulfate as the main impurities that cannot be further washed out. In contrast to other processes, the product is spherical with a median diameter of 0.208 mm and a narrow particle size distribution with 0.169 mm as the lower limit and 0.255 mm as the upper 10-of-100 size percentile.

### Example 4: Thermal Insulation

A cylindrical steam lance with an immersion depth of 5 m protrudes into a reactor with a volume of 300 m³, which circulates a suspension of Li₂ CO₃ and an 80% saturated NaCl solution.

The steam lance is operated with saturated steam at a temperature of 160° C. The Li₂CO₃ suspension boils at 105° C. The solution has a thermal conductivity of 6 W/(mK). A Nusselt number of 3434 was determined for this arrangement and process configuration. In order to achieve a temperature difference of less than 0.1 K between the medium temperature and the surface temperature of the outside of the steam lance, insulation with a thermal conductivity of 0.05 W/(mK) and a layer thickness of approx. 2 cm is required.

1. A reactor comprising a cylindrical vessel with a centrally arranged axial agitator (6) with a guide tube (3), which generates a flow directed towards the bottom of the vessel, as well as an annular clarifying ring (1) concentrically surrounding the axial agitator (6) and an overflow (2),
characterized in that the reactor comprises a thermally insulated feed pipe (7) for introducing an aqueous phase, solid suspension, or a gas phase, which protrudes into the interior of the reactor vessel.

2. The reactor according to claim 1, wherein the temperature gradient between the surface of the thermally insulated feed pipe (7) and the interior of the reactor is less than 1 K.

3. The reactor according to claim 1, wherein the thermal insulation of the feed pipe prevents crystal formation on the surface of the feed pipe.

4. The reactor according to claim 1, wherein the thermally insulated feed pipe (7) is part of a circulation line (12).

5. The reactor according to claim 1, which further comprises flow deflection means (4), a wall flow breaker (5) and/or a bottom outlet (10).

6. The reactor according to claim 1, comprising an external clarifier (9) arranged outside the reactor, into which the reactor overflow from the overflow (2) of the reactor is introduced.

7. The reactor according to claim 6, wherein the external clarifier (9) comprises a clarifier cone without a rake, a round thickener with a rake, a lamella clarifier, a centrifuge, or a decanter.

8. The reactor according to claim 1, comprising two or more thermally insulated feed pipes (7).

9. The reactor according to claim 1, wherein two feed pipes (7) are arranged asymmetrically or symmetrically to the axial stirrer (6).

10. The reactor according to claim 1, wherein at least one feed pipe (7) protrudes into the guide tube of the reactor (3).

11. The reactor according to claim 1, wherein the reactor comprises a static mixer (8) in a circulation line (12).

12. The reactor according to claim 1, wherein the reactor comprises a heatable circulation line (12).

13. The reactor according to claim 1, wherein the thermally insulated feed pipe (7) comprises an outer wall that is heated by ambient air or by a liquid medium.

14. The reactor according to claim 1, wherein the thermally insulated feed pipe (7) comprises an insulating jacket with an insulating layer, and the insulating layer of the insulating jacket has a thermal conductivity of 0.05 W/(mK) or less.

15. A method for crystallization in a cylindrical reactor equipped with an agitator, wherein the crystallization method comprises the following step:
a) initiating a precipitation reaction by supplying at least one liquid or gaseous medium into a medium inside the reactor, wherein the supplied medium has a higher temperature than the reactor medium, whereby a temperature change occurs in the reaction medium inside the reactor, which induces or promotes the precipitation reaction, without introducing a surface into the reactor that creates a temperature gradient with respect to the reactor medium.

16. The method according to claim 15, comprising introducing a thermally insulated steam lance (7) into the reactor vessel, through which the supplied medium is introduced into the reactor medium.

17. A battery of reactors according to claim 1, wherein at least two of the reactors are connected in series.

18. The battery of reactors according to claim 17, wherein a forward reaction takes place in the first reactor and a chemical reverse reaction takes place in the second reactor.

19. Use of the reactor according to claim 1 for the production of lithium carbonate, preferably by introducing hot water or steam into a lithium hydrogen carbonate solution.

20. Lithium carbonate as a spherical crystalline substance with a median diameter of 0.15 mm to 0.75 mm as the median value with a narrow particle size distribution with a 10% size percentile between 0.09 and 0.65 mm up to a 90% size percentile between 0.20 mm and 0.80 mm and, particularly preferably, with a particle diameter of 0.208 mm with a particle size distribution from a 10% size percentile of 0.169 mm to a 90% size percentile of 0.255 mm.
